(19) United States
(12) Patent Application Publication
(10) Pub. No.: US 2009/0307392 A1
(43) Pub. Date: Dec. 10, 2009

(54) INTELLIGENT CABLE AND FLEXIBLE MULTIPLEXER

(75) Inventors: Paul Mychalowych, Birmingham, MI (US); Terry Spross, Macedon, NY (US)

Correspondence Address: YOUNG BASILE, 3001 WEST BIG BEAVER ROAD, SUITE 624, TROY, MI, 48084, US

(73) Assignee: Paul Mychalowych, Troy, MI (US)

(21) Appl. No.: 12/136,297

(22) Filed: Jun. 10, 2008

(51) Int. Cl. G06F 3/00; G06F 13/12; G06F 13/38

(52) U.S. Cl. 710/51; 710/72; 710/67

(57) ABSTRACT

Embodiments of an intelligent cable and flexible multiplexer are taught herein. The cables and multiplexers can receive any brand or electronic gages using a variety of asynchronous or synchronous communication protocols and provide outputs according to a desired communication protocol, including USB and RS232.

### FIELD OF THE INVENTION

The invention relates, in general, to the interconnection of sensor devices monitoring variables and, more particularly, an intelligent cable and a flexible multiplexer capable of interfacing various sensor (gage) devices.

### DESCRIPTION OF THE RELATED ART

Gage devices are known that monitor various variables for further analysis. Currently, a variety of gage manufacturers are known, and each transmits this data using proprietary hardware and/or software. Further, various gage signal converters and multiplexers are known. Each has limitations and unique characteristics.

### SUMMARY

One embodiment of an intelligent cable taught herein is a cable for connecting a gage device to a processing unit. The cable includes a housing, an input connector mounted in a surface of the housing, means for coupling the input connector to a gage output, an output connector mounted in the surface of the housing, means for coupling the output connector to a processing unit and a microprocessor arranged inside the housing and configured to receive input from the input connector and to provide output to the processing unit.

The processing unit can be, for example, a flexible multiplexer as taught herein. One multiplexer taught herein for monitoring a plurality of gage devices coupled to the multiplexer comprises a housing, a plurality of input connectors mounted in a surface of the housing, at least one of the plurality of input connectors coupled to a gage device, an output connector mounted in the surface of the housing and connectible to a processing unit, a RS232 buffer coupled to the output connector, a bidirectional USB-COM port coupled to the output connector and a microprocessor arranged inside the housing. The microprocessor is configured to receive input data from one of the plurality of input connectors coupled to a gage device, the input data transmitted according to one of a synchronous protocol and an asynchronous protocol, and selectively convert the input data to one of RS232-compatible asynchronous data for transmission through the RS232 buffer to the output connector and USB-compatible data for transmission through the USB-COM port to the output connector.

These and other features of the invention are taught as described in more detail hereinafter.

### BRIEF DESCRIPTION OF THE DRAWINGS

The description herein makes reference to the accompanying drawings wherein like reference numerals refer to like parts through the several views, and wherein:

FIG. 1 is a simplified functional block diagram of a system for reading data incorporating aspects of the invention;

FIG. 2 is a block diagram of a multiplexer according to one embodiment,

FIG. 3 is a flow chart showing USB keyboard/virtual COM port operation;

FIG. 4 is an operational diagram of an intelligent cable according to a first embodiment and a third embodiment;

FIG. 5 is a mechanical layout of the intelligent cable according to the first embodiment;

FIG. 6 is an operational diagram of an intelligent cable according to a second embodiment and a fourth embodiment;

FIG. 7 is a mechanical layout of the intelligent cable according to the second embodiment;

FIG. 8 is a mechanical layout of the intelligent cable according to the third embodiment;

FIG. 9 is a mechanical layout of the intelligent cable according to the fourth embodiment;

FIG. 10 is an operational diagram of an intelligent cable according to a fifth embodiment;

FIG. 11 is a mechanical layout of the intelligent cable according to the fifth embodiment;

FIG. 12 is an operational diagram of an intelligent cable according to a sixth embodiment;

FIG. 13 is a mechanical layout of the intelligent cable according to the sixth embodiment.

FIG. 14 is an operational diagram of an intelligent cable according to a seventh embodiment;

FIG. 15 is a mechanical layout of the intelligent cable according to the fifth embodiment; and

FIG. 16 is a perspective view of a multiplexer according to one embodiment of the invention coupled to a second multiplexer according to one embodiment of the invention.

### DETAILED DESCRIPTION

Embodiments taught herein allow multiple inputs from gages to be routed through a single connection to a computer. Signal formats from various manufacturers are converted and output in a common format for export to a computer. Synchronous output is full-functioning and supports high speed updates. In addition to supporting individual setups for each of the gages, embodiments provide the ability to customers to update gage and operating programs. The invention can be incorporated into a variety of applications for statistic process control (SPC)₃ among other data analysis applications.

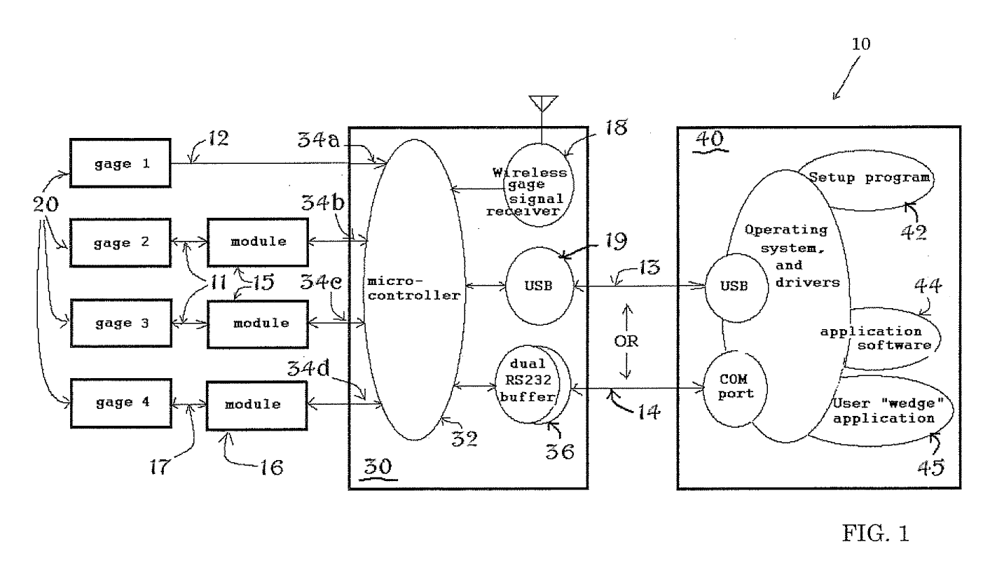

Various features of the invention are further explained with reference to FIGS. 1-16.

FIG. 1 is a simplified functional block diagram of a system 10 for reading data incorporating aspects of the invention. In the system 10 are included multiple gages 20. Here by example there are four gages 20, gage 1-gage 4. Each of the gages 20 is input to a multiplexer 30, which provides data from the gages 20 to a computer, such as personal computer (PC) 40 through a universal serial bus (USB) interface bus 19 (also called a virtual logical COM port portion herein). The USB conforms to the USB standard.

The gages 20 can include a wide variety of gages from various manufacturers. For example, various synchronous gages are possible, Some known manufacturers of such gages are Mitutoyo America Corp. (hereinafter MTI) of Aurora, L, Mahr Federal, Ono Sokki, etc., as is discussed in more detail hereinafter with respect to the intelligent cables. The multiplexer 30 can also connect CDI bit parallel, byte serial gage types, These types are represented as “gage 1” in FIG. 1, and they can connect directly with a simple cable as shown. As shown, a simple cable does not have any active electronics, only simple connections, but such a cable may contain passive components such as resistors.

The multiplexer 30 also has the capability to accept intelligent cables according to the fifth and sixth embodiments described hereinafter, with multiple tagged readings. Examples of the fifth embodiment 15 of an intelligent cable connect with gages (gages 2 and 3, by example) that have a single or bidirectional RS232 protocol 11. An example of the sixth embodiment 16 of an intelligent cable is shown connected with a gage (here, gage 4) that has a USB signal 17.

The multiplexer 30 includes a main controller 32 receiving inputs from gage inputs 34a-34d (collectively, gage inputs 34). The main controller 32 can be, for example, a microcomputer including a random access memory (RAM), a program memory (FLASH), non-volatile Electrically Erasable memory (EEPROM) and a central processing unit (CPU) in addition to various input and output connections. Generally the functions described herein for the main controller 32 are performed by execution by the CPU of one or more programs stored in FLASH. Of course, some or all of the functions described can also be implemented in whole or in part by hardware. The multiplexer 30 preferably includes buffer memory sufficient to store MN, MAX, AVE for all ports and complete reports that can be transmitted (up to 8 ports per multiplexer, for example). The gage inputs 34 are generally firmware- or software-programmed hardware devices as described in more detail hereinafter. Each of gages 1 through 4 is connected to a respective gage input 34a through 34d. Due to the inventive features of the multiplexer 30 described herein, simultaneous port input is possible. The multiplexer may have an optional wireless gage signal receiver 18.

PC 40 is a conventional computer including a processor such as a CPU, RAM, ROM and various input and output connections, including a keyboard (not shown in FIG. 1). The computer is not limited to a personal computer and can be, for example, a workstation or server. One of the input-output (IO) connections of the PC 40 is a standard USB port to receive signals 13 from the multiplexer 30 and to transmit instructions thereto. The protocol of the USB signal from the multiplexer USB interface bus 19 can be either keyboard or a virtual COM port as described hereinafter. Alternately, if a USB connection is not available or desired a connection can be made using an RS232 connection 14 between a dual RS232 buffer 32 of the multiplexer 30 and the COM port of PC 40. In addition to functioning according to a standard operating system, PC 40 includes two programs executed by the CPU and generally stored in ROM. These are a setup program 42 and optionally a software program referred to in the industry as a “wedge” program 45. A wedge program converts keystroke data entered into a COM port into virtual keystroke data that enters directly into an application. A user application 44 program for SPC or other data collection program would also be invoked while the multiplexer is in use. Each of these is discussed in turn hereinafter.

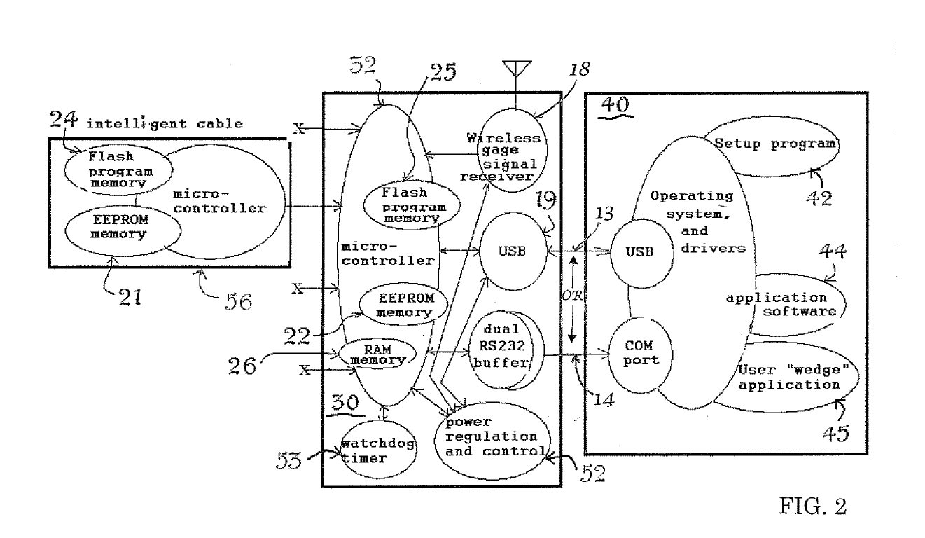

FIG. 2 is a block diagram of a multiplexer 30 showing additional features implemented in hardware and firmware. This block diagram includes arrows showing communications to the various functional components. Multiplexer 30 has four synchronous gage input connectors. Of course, four connectors and the composition of the types of connectors are shown by example only; the number and types can vary.

A single intelligent cable 56 is shown connected to the multiplexer 30 by example in FIG. 2. Its capability as described hereinafter applies to each intelligent cable connected to the multiplexer 30. EEPROM 22 integral to the microcontroller 32 stores individual setups for the input gage signal parameters. Further setup information subsequently stored in EEPROM 22 can be used to update the gage and operating programs by an end user. Intelligent cable 56 illustrates an internal configuration common to all intelligent cables described herein, including cables 15, 16 shown in FIG. 1.

The USB communication to the PC 40 is governed by two main protocols. Details of these protocols are discussed in more detail hereinafter. Briefly, the first is a virtual logical COM port portion 19 through which all setup, flash updates to the multiplexer microcontroller 32 and flash updates to the intelligent cables 56 are ported. The setup program 42 directs two functions: setup parameters and flash program updates. The multiplexer 30 produces both individual gage readings, triggered when allowed by the gage, and total indicated runout (TIR) including max and min over the selected interval as discussed hereinafter. In addition to these readings, average, differential normal and differential TIR outputs are also possible.

The second protocol is an optional USB Keyboard protocol portion of 19. If active, the USB Keyboard protocol outputs readings directly to an application in a like manner as direct keyboard entry.

Optionally, rotary switch(es) may be used to select the desired port whenever the multiplexer 30 is used without a PC 40 with operating setup software, whereby gage value readings can be obtained as directed by the manual setting of the switches.

Generally, power from a USB port alone is not adequate for the multiplexer 30 even if only a few low power USB devices are coupled to the multiplexer 30. Due to the need of the multiplexer 30 for current, it is desirable to have an external power supply (not shown) electrically coupled to the multiplexer 30 through a power jack (such as power jack 83 shown in FIG. 5, for example). The external power supply can be coupled to a power switch mounted on a housing of the multiplexer 30. The power switch can be a rocker switch, for example, or can be a push button reset/attention switch.

Power regulation and control circuitry 52 within the inventive multiplexer 30 help support the suspend mode of the USB requirements as well as protect the multiplexer from external electrical faults. A feature of the microcontroller 32 used is a watch-dog timer 53 that, together with the operating program, detects incorrect operation and provides an automatic recovery scheme.

The multiplexer 30 can be coupled to the PC 40 and to other multiplexers 30. As shown in FIG. 2, multiplexer 30 includes two conventional universal asynchronous receiver/transmitters (UARTs) 36 to control the interface of the multiplexer 30 to attached serial devices. One of the UARTs 36 communicates with the PC 40 and the other is used to communicate with other serial devices, in particular another multiplexer 30, using EIA RS232 standard for serial binary data signals. Use of the UARTs 36 and RS232 is optional and desirable when operating with legacy computers and/or with multiple multiplexers 30 so that only one connection is made to the PC 40. A second multiplexer 30 when using the USB output with the KEYBOARD protocol can optionally be connected with an additional USB cable to the multiplexer. If the application program supports communicating to multiple COM ports then this can also be true of the VIRTUAL COM protocol of the USB interface bus 19. In this case, no RS232 cables need be used. The typical connection, however, is that a primary multiplexer 30 is connected to the PC 40 via USB and all subsequent multiplexers are connected to each other via RS232. The advantage of this scheme is the inventive multiplexer 30 arbitrates the port numbers automatically.

Common DB9F connectors can be used to provide the interconnection such that individual cables interconnect units. In order to forward gage readings out the USB interface bus 19, the master multiplexer 30 monitors output from the other multiplexers 30 and forward the data to the host PC 40. Conversely, commands destined for the other multiplexers 30 are relayed. Arbitration of port assignment is done through this communication method as well.

Although not illustrated in FIGS. 1 and 2, certain embodiments of the multiplexer 30 can include LEDs to indicate the status of the multiplexer 30 and/or each of the input ports 34a-34d. For example, one or more LEDs can indicate whether or not the multiplexer 30 is operating. According to one embodiment, a main LED reports power on and can, by its pulse length, inform the user of the level of operation of the multiplexer 30 as discussed in more detail hereinafter. Other LEDs can be coupled to each of the input ports 34a-34d to indicate faults, data transmission, etc., of the connected gages, here gage 1-gage 4. For example, green can indicate normal access to the gage, while red can report can report an error with the gage connection or a slave to host command indicating out of tolerance or out of control statistical conditions. Such LEDs can be provided on the top of the multiplexer 30 housing, for example.

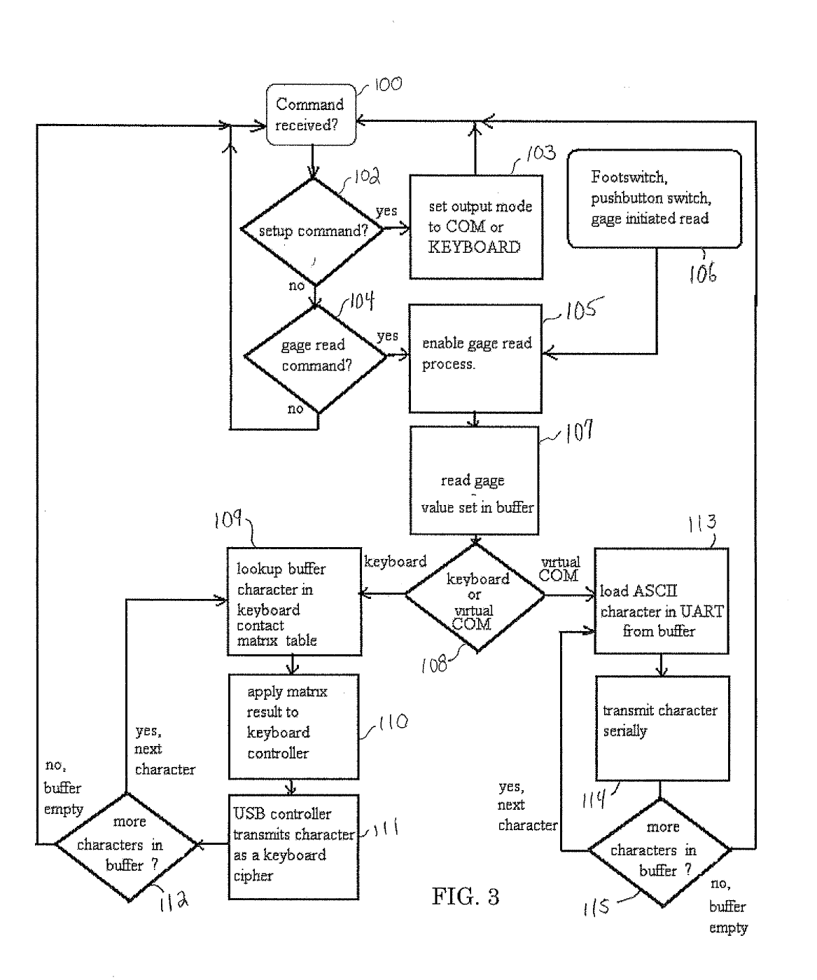

FIG. 3 demonstrates the logical flow used in multiplexer 30 when the USB interface bus 19 is used.

Once any gage 20 is connected, either directly or through a cable 56, the multiplexer 30 is able to read the value of the gage 20 as commanded and setup at 100.

At 102, a decision is made if the command is a setup command to determine a selection between the two modes, keyboard protocol or virtual COM protocol of the USB connection. At 102, the process advances to 103, where the output mode of the cable 56 is set to COM or KEYBOARD. After setup, the multiplexer 30 returns to 100 to continue to monitor for the next command.

If the command received is not a setup command at 102, the multiplexer 30 queries as to whether the command is a gage read command at 104. If the command received is not a gage read command at 104, the process returns to 100 to monitor for the next command. If the command received at 104 is a gage read command at 104, the gage read process is enabled at 105. If so setup, also monitored continuously are a footswitch, pushbutton switch or a gage signal initiation that can occur at 106. The process at 106 includes indirect triggering in the case of cables 15 or 16 whereby the connected cable 56 monitors the gage 20 for a trigger signal, a connected footswitch 80 at the cable 56 or the depression of the cable built-in read switch 81 and then relays this trigger to the multiplexer 30. A footswitch connected directly to the multiplexer 30 or a software timed function or sequence can also begin the trigger at 106. A successful triggering of any of these events will also begin the gage read process at 105.

The gage read process at 105 includes reading the designated gage 20 in context of the specific trigger and according to the appropriate protocol for the connected gage 20 or cable 15 or 16. The gage read value is saved in the port-associated gage value buffer within the multiplexer 30. The reading process may or may not include a mathematic formula applied to a single or plurality of gages 20, including but not limited to a set of port-associated registers for minimum, maximum or calculated average, or the difference between the minimum and maximum or the difference between gages 20 associated with more than one port. When the reading process is complete at 105, processing advances to 107 whereby the stored value is converted to a designated format to be made available for output. Additional processing after this step depends on whether the output mode of the multiplexer 30 was set to COM or KEYBOARD at 103. That is, at 108, if the output mode of the multiplexer was set to KEYBOARD at 103, processing advances to 109.

At 109, the multiplexer 30 looks up the buffer character in a keyboard contact matrix table stored in memory of microcontroller 32. The multiplexer 30 then applies the matrix result to the keyboard controller portion of USB interface bus 19 at 110. At 111, the USB keyboard controller transmits the character as a keyboard cipher.

After this transmission, processing advances to 112, where the multiplexer 30 queries whether there are more characters in the appropriate port buffer. If there are more characters in the buffer, steps 109 through 111 repeat until the buffer is empty in response to the query at 112. Then, the multiplexer 30 returns to monitoring for received commands at 100 and is also monitoring for triggered events as previously described at 106.

In contrast, at 108, processing advances to 113 if the output mode of the multiplexer 30 was set to COM at 103. ASCII characters from the buffer associated with the port are loaded into the UART 36 that connects within the multiplexer 30 to the virtual COM portion of USB interface bus 19. Then, the characters are serially transmitted to PC 40 at 114.

After this transmission, processing advances to 115, where the multiplexer 30 queries as to whether there are more characters in the associated buffer. If there are more characters in the associated buffer at 115, steps 113 and 114 repeat until the buffer is empty in response to the query at 115. Then, the multiplexer 30 returns to monitoring for received commands at 100 and is also monitoring for triggered events as previously described at 106.

Although this USB flow of FIG. 3 is described with reference to multiplexer 30, it is worth noting that this USB flow also applies to the second and forth embodiments of the intelligent cables 15, 16. These cables 15, 16 have an identical USB output supporting both the keyboard and the virtual COM protocols for direct connection to the PC 40.

Next described are the functional modes of the multiplexer 30. The modes operate at three levels.

Level 1 includes several functions. One function includes accessing the operating program of the multiplexer 30. Also at Level 1, reports on the boot firmware level and main firmware level are prepared. The boot firmware is not able to be changed. Main firmware can be updated at Level 1, and a functional test of the multiplexer 30 hardware is performed. The operating program (software) and firmware are discussed in more detail hereinafter.

At Level 2, connected gage intelligent cables described hereinafter are accessed. Reports on individual intelligent cable boot firmware level and module firmware level are also made at Level 2. The intelligent gage cables' boot firmware is not able to be changed. Intelligent cable firmware can be updated at Level 2 in coordination with the specific embodiment. A functional test of each cable and also any directly connected MTI or Federal gage hardware may also performed. Operations at Level 2 also allow monitoring of other connected multiplexers 30. The firmware is discussed in more detail hereinafter.

Normal operations occur at Level 3, including normal setup of any intelligent gage cables, and normal setup of functions of the multiplexer 30. Optionally, a simple report of the status of the connected gages is prepared. Also at Level 3, testing of asynchronous gages when connected thru intelligent cables of the fifth embodiment, described hereinafter, is performed to automatically detect their baud rate, pin configuration and view their serial string for the user to select and apply the desired value in a long string. The value and method of detecting the value is a part of the setup.

Parameters of known gages can be selected from a setup menu at Level 3. For example, automatic/manual gage parameters can be presented, fields from which readings are to be extracted can be selected, single or multiple parameters can be selected by tag assignment etc. The setup menu accesses a database maintained on the PC 40, by example, and the necessary parameters are passed to the multiplexer 30. Therefore, some additional commands for non-asychronous gages are supported in this mode.

Additional details related to these functional modes are discussed hereinafter. It should be understood that the grouping of these levels and the functions therein are examples only. More or fewer levels are possible.

As can be seen from the above descriptions, programming of various firmware and software is involved in these functional modes of the multiplexer 30. In FIG. 2, the setup program 42 operating in PC 40 operates with a connection thru the USB interface bus 19 and contains special protocol instruction to the microcontroller 32 operating with its firmware in flash memory 25. When necessary, a firmware update set of commands can update the firmware stored in the flash memory 25. During the process RAM memory 26 is used as a buffer. The firmware is programmed to fulfill a number of requirements.

The firmware of the multiplexer 30 allows for, for example, an interrogation into the status of any connected intelligent cable(s), restarting the intelligent cable(s), immediate gage read(s), commands to accumulate MIN, MAX and TOTAL reads and an LED override. The LED override could, for example, be used to indicate a new operation level for the multiplexer 30 when a LED 78 of the intelligent cable would otherwise be indicating a read status.

For program loading and re-flash, the firmware loads individual pages and performs a checksum verification. It is also desirable that the firmware flash its status using the LED 78. For example, a green pulse can indicate initialization. Green can be projected during a gage read, with a visible pulse width. Red can be shown on an error when, for example, there is an error reading the gage, or when the PC 40 issues a command to the multiplexer 30 to indicate that a reading is out of control limits.

The multiplexer 30 idles in a main loop after setup. That is, it sleeps when no conforming gage or no gage at all is detected. Further, it listens for any connected gages based on status from connected intelligent cables and ignores footswitch closures related to gages whose data cannot be spontaneously requested.

Additionally, the intelligent cables have the capability to override or restrict commands such as to accumulate MIN, MAX and TOTAL reads if the respective connected gage is not capable of such. Further, in at least one embodiment, MIN,MAX data is not reported unless at least three successive readings of the associated gage that is either directly connected or connected via an intelligent cable have automatically occurred.

Upon connection of an intelligent cable 56 of the fifth or sixth embodiments 15, 16, the firmware revision level and status of the cable can be conveyed through the multiplexer 30 to the host PC 40.

Similarly, for program loading and re-flash of the fifth or sixth embodiments 15, 16, the firmware loads individual pages and performs a checksum verification, in addition to indicating its status. Referring to FIG. 2, the process has been previously described for updating of re-flashing the multiplexer 30. A similar process occurs when re-flashing the intelligent cables 56. Commands including the program data originating at the PC 40 are forwarded through the multiplexer 30 to the program running in the intelligent cable 56 (shown by example) using its RAM (not shown) and re-flashing the same program data in flash 24. Similarly, setup information destined for EEPROM memory 21 originates from the setup program 42.

The PC 40 hosts the setup program 42, which is implemented in software. The program 42 is operable to communicate with the multiplexer 30 via a generic USB COM device assigned as any valid COM number, which can include numbers greater than four in certain embodiments.

The functions of the PC program 42 are many and varied. The program 42 can operate in demo mode and can offer a clear, easy-to-use graphical user interface (GUI) offered in more than one language, such as English, Spanish and French. It would be desirable to provide a window to verify keyboard USB operation.

The PC program 42 performs the function of assigning the addresses to multiple connected multiplexers 30. For example, this can be done by operator manipulation of footswitches 80 or by connecting gage cables or taking gage readings on the units in the order desired for assignment. The PC program 42 can show this activity on-screen.

The PC program 42 can also access the operating program of the multiplexer 30 and thereby provide reports. One such report provides a status of the boot revision level, for example. With respect to the main firmware Level 1, the PC program 42 provides a view of the status with a concise explanation, an option to update and a functional test of the hardware with a concise view of the result.

For the main firmware of Level 2, the PC program 42 similarly provides a view of the status with a concise explanation. A view showing the status of individual gage modules is also provided. Revision levels of individual firmware can be reported, and an option can be offered to update each one independently. Also at Level 2, the PC program 42 can report results of the functional test.

With full operation of the multiplexer 30 at Level 3, normal parameter setup of gage modules can be undertaken by the PC program 42. Similarly, normal setup of the multiplexer 30 occurs (i.e., whether and when to command TIR start and stop, which ports are active, etc.). The PC program 42 can verify connected gages. Also at Level 3, testing of gages, including asynchronous gages, can be triggered. Finally, the PC program 42 can enable normal full operation of the multiplexer 30.

At Level 3, the PC program 42 can also provide a database of known gages and their setups to the multiplexer 30. The database can be accessed by part number or manufacturer/model name. The PC program 42 can use this information in conjunction with the multiplexer control 32 to apply setups to the gage devices.

As mentioned previously, testing of asynchronous gages can be triggered by the PC program 42 at Level 3. As part of this test, the PC program 42 can display the received string and be used to select a desired field with a mouse. A letter or number is assigned to the field in question, and the information is transferred to the multiplexer 30 as a set of parameters.

The software of the PC program 42 includes a function to create a log file for troubleshooting. This allows any gage setup to continue for an extended period and stores captured readings in a log file. The multiplexer 30 can also be set up by the PC program 42 to have one of two error reporting philosophies, that is, to either report no errors or to report an error whenever reading accuracy is in doubt.

The PC program 42 is not currently intended to spool readings to other application or to provide for any kind of statistical analysis. Instead, these functions are performed by other applications, such as user application 44. For other applications to receive valid readings, in this embodiment they either obtain communications via a generic USB logical COM port or accept keyboard entry using a USB keyboard device in the multiplexer (i.e., using keyboard protocol).

Next described are intelligent cables that can be used with the multiplexer 30 or separately with existing multiplexers or for direct connections to a host such as PC 40. Some embodiments of intelligent cables are modules with detachable simple cables. Taken together, these are referred to herein as intelligent cables. The intelligent cable allows conversion of various gage types into a common format with a standard protocol. It allows the various methods of selecting the desired measurements from the gage transmitted data and the various output format possibilities to be setup and saved in memory in the cable without opening the device to set any switches or jumpers through the use of a setup program on PC 40. The intelligent cable can also be used in the absence of PC 40 as it includes a way to make some settings on switches to provide satisfactory operation.

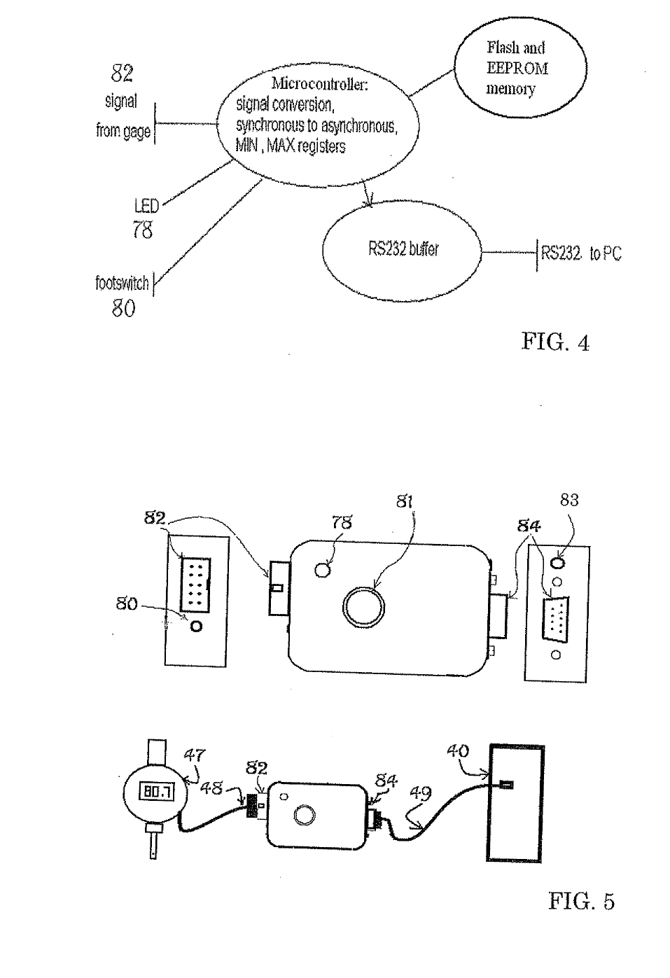

Seven embodiments of an intelligent cable are described herein, but the invention is not limited thereby. The first receives data input in MTI format, that is, MTI input, and produces RS232 output. The second similarly receives MTI input and produces USB output. The third receives other synchronous input and produces a RS232 output, while the fourth also receives other synchronous input but produces a USB output. While the MTI format is a synchronous format, the second and third embodiments support synchronous protocols other than MTI. The fifth receives an asynchronous input (particularly a RS232 input) and produces a synchronous output, such as MTI output. The sixth receives a USB input and produces a synchronous output, such as MTI output. Finally, the seventh receives an MTI input and produces USB output. The seventh differs from the second in that it is simplified. The intelligent cables are described with reference to FIGS. 4-13.

Each of the intelligent cables has certain common characteristics. First, all of the intelligent cables can have an LED, such as bicolor (red/green) LED 78, a pushbutton switch 81 for data entry and a footswitch connector 80 that accepts a miniature plug from a footswitch. All have a power connector except USB output types of the second, fourth and seventh embodiments. As shown in these embodiments, the housing is a split case, and due to the desired sizes shown each has an internal printed circuit board with all components mounted directly to the board (LEDs, connectors, etc.).

Setup commands discussed hereinafter allow additional functionality, including customizing the prompt string, output string, using dwell switch closure for TIR and setting custom output formatting on RS232 output types. More details of each of the types of intelligent cables are described next with reference to the first through seventh embodiments. Thereafter, operation of the intelligent cables is described with reference to the description of the software.

FIG. 4 is an operational diagram of an intelligent cable according to the first embodiment, while FIG. 5 is a mechanical layout and typical interconnect diagram of the intelligent cable according to the first embodiment. Although a number of connectors are possible to connect gages with synchronous signals to the multiplexer 30, one preferable connector for the first embodiment is a 10-pin connector compatible with gages from MTI. Of course, other synchronous gages could be connected with an adapter cable, including those from Mahr Federal, Inc. of Providence, R.I. These common gage manufacturers can be automatically detected by the multiplexer 30, while others may require manual setup for assignment. The multiplexer 30 accordingly readily interfaces with MTI standard Ready-Request-Sync sequence and MTI clones that do not use ready, that is, Sync starts without ready and supports idle listening for the gage for single send gages. The function of idle on footswitch is also supported. That is, each synchronous input module 15 includes a footswitch jack 80 to receive input signals from a footswitch. The input signals from the footswitch (either a footswitch toggle or a footswitch dwell) can be used to, for example, start and stop a selected interval for a read of TIR including max and min over the selected interval. Buffer memory should be sized sufficient to store the data of these triggered sequences, such as 850 bytes.

The output is a standard RS232 that can accept setup commands and prompts as discussed in more detail hereinafter. FIG. 5 shows typical MTI digital indicator gage 47 as an example connected to the first embodiment with simple MTI cable 48. The output 84 of the first embodiment is connected to PC 40 at its standard COM port connector using a cable 49. Default settings are desirable. In one example, default setup is to take a single reading on ready, prompt or footswitch closure, and the output format is simple reading. Default output framing can be, for example, 9600 baud, 8 data bits, no parity, with 1 stop bit. In this embodiment of the intelligent cable, the cable includes a 16-position rotary switch that allows other baud rates, allows continuous streaming, MIN only, MAX only or TIR on toggle type footswitch closure, or allows long-reading, comma-delimited format.

Operation of the first embodiment includes a power up initialization and self test. Three modes of operation are possible, a boot only mode, a valid program mode where main operations are enabled and a re-flash mode where writable portions of the firmware can be re-programmed. The firmware can read the gage data in more than one manner depending on the type of gage. For MTI gages, for example, the firmware sends a request. For other gage types, a command to capture the current transmission is performed.

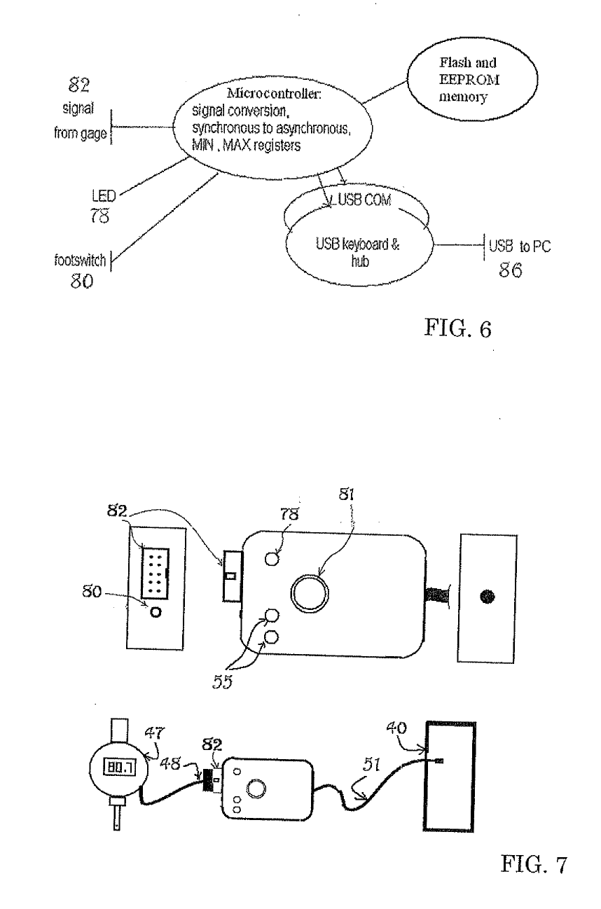

FIG. 6 is an operational diagram of an intelligent cable according to the second embodiment, while FIG. 7 is a mechanical layout of the intelligent cable according to the second embodiment. Like the first embodiment, the input has an MTI 10 pin connector (male) 82. Accordingly, input signals supported include those from gages such as MTI and clones and certain Mahr Federal gages. Identification of a MTI/Federal attached gage is automatic. The output is a tethered USB cable 51 coupled to an internal bi-directional USB-COM port that uses a driver generally supplied by the chip manufacturer. Alternately, a keyboard output chip can be enabled using a standard USB keyboard driver, such as that available in Windows. The virtual COM port accepts setup commands and prompts as discussed in more detail hereinafter.

Like the first embodiment, default settings are desirable. In this case, default setup includes a single reading on ready, prompt or footswitch closure. The default output is a USB keyboard output with reading-only characters. Also like the first embodiment, the intelligent cable can include an internal 16-position rotary switch that allows COM port output, allows continuous streaming, MIN only, MAX only or TIR on toggle type footswitch closure, or allows long-reading, comma-delimited format. Note that FIG. 7 differs from FIG. 5 through the inclusion of a USB tethered cable 51.

Desirable, but not necessary, is the feature of a dual LED 55 display (see FIG. 7) on COM-USB function indicating communications. For example, green indicates cable to PC data, and red indicates PC to cable data.

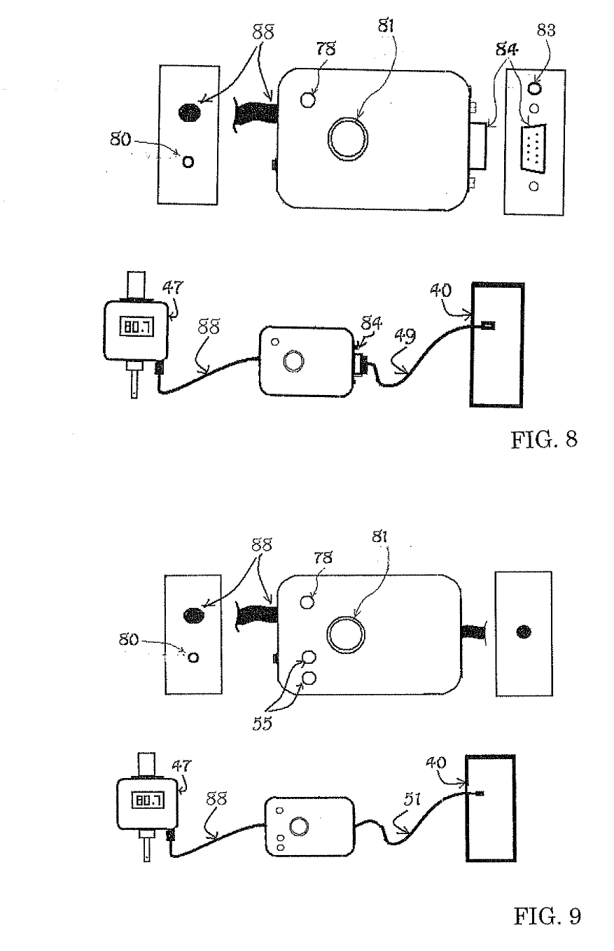

FIG. 8 is a mechanical layout of the intelligent cable according to a third embodiment. Like the first embodiment, the input is synchronous, while the output is RS232. Accordingly, the operational diagram of the first embodiment in FIG. 4 also illustrates the intelligent cable according to the third embodiment. The third embodiment is the same as the first embodiment except for the input. As shown in FIG. 8, the input has a tethered cable with a gage connector 88 capable of direct connection to a gage, such as digital indicator gage 47. Synchronous signals supported include signals from synchronous gage types other than MTI. These include, but are not limited to, Mahr Federal Maxum gages, the Tri-Mos height gage TVM and Mahr 814, all available from Mahr Federal Inc., Providence, R.I., gages from Ono Sokki Co., Ltd., Midori-ku, Yokohama, Japan, Helios-Sylvac gages (available from Mahr Helios Messtechnik GmbH & Co. K G, Dorzbach, Germany or Sylvac S A, Crissier, Switzerland) and clones, the Fowler Max-Cal, available from Fred V. Fowler Company, Newton, Mass., Scherr-Tumico xx-2000 models available from S-T Industries, Inc., of St. James, Minn., and Brown & Sharpe 1013 HG available from Brown & Sharpe of North Kingstown, R.I.

FIG. 9 is a mechanical layout of the intelligent cable according to the fourth embodiment. Like the second embodiment, the input is synchronous, while the output is USB. Accordingly, the operational diagram of the second embodiment in FIG. 6 also illustrates the intelligent cable according to the fourth embodiment. The fourth embodiment is the same as the second embodiment except for the input. As shown in FIG. 9, the input has a tethered cable with a gage connector 88 capable of direct connection to a gage. Synchronous signals supported include signals from synchronous gage types other than MTI described with reference to the third embodiment above.

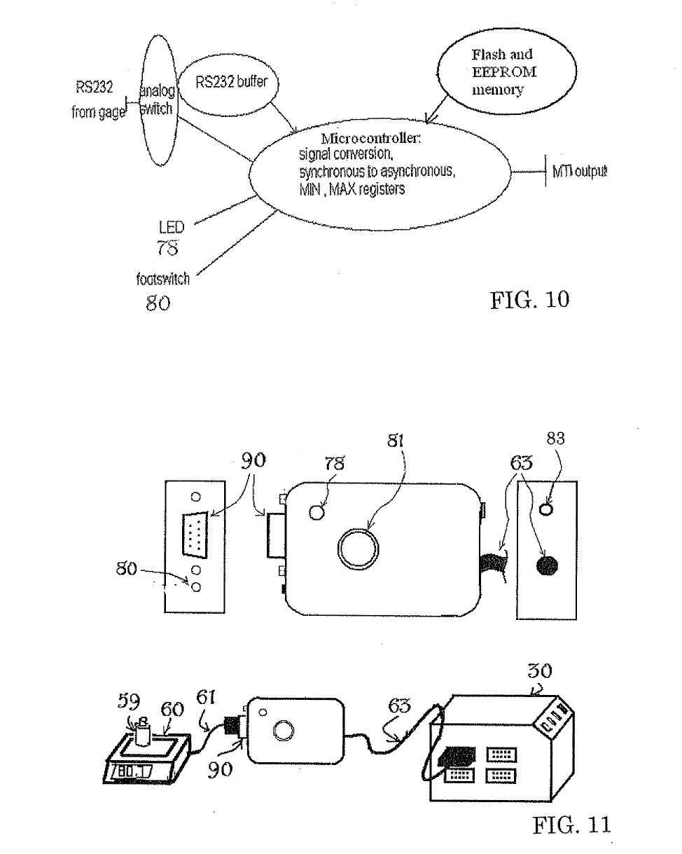

FIG. 10 is an operational diagram of an intelligent cable according to a fifth embodiment, while FIG. 11 is a mechanical layout of the intelligent cable according to the fifth embodiment. Generally, the input is a DB9 male (DB9M) connector 90 to conform to the typical PC corn port connector for which most serial gage cables supplied by gage manufacturers conform. In such connectors, the signal direction for pin 3 is usually from the external device to the PC, but some cables intended for other DB9M connectors may have pin 2 active. Multiplexer controller 32 desirably detects and automatically switches the functions of pin 2 and 3. Of course, other connectors are possible. The input can be configured for Data Terminal Equipment (DTE) and Data Communications Equipment (DCE) configurations (using no jumpers). Some gages with asynchronous signals use transistor-transistor logic (TTL) levels instead of EIA RS232 levels. The multiplexer controller 32 detects this in a test of the gage connected to the multiplexer 30 as discussed in further detail hereinafter. Both TTL and EIA RS232 levels are supported. Like the firmware for the first embodiment, operation of an asynchronous gage fifth embodiment includes a power up initialization and self test. Four modes of operation are possible, a boot only mode, a valid program mode where main operations are enabled, a re-flash mode where writable portions of the firmware can be re-programmed and a test gage mode for auto-baud detection. Other commands from the multiplexer 30 that take precedence over the internal operations of the intelligent cable include a command to start auto-baud detection and return status and a command to load parameters for the interface of the gage.

FIG. 11 displays by example a weigh scale 60 weighing a specimen part 59. (Weigh scales are typical of gages that have a RS232 output.) A standard RS232 cable, a cable supplied by the gage manufacturer, or a custom cable providing the pinout required at the gage termination 61 connects to the fifth embodiment at connector 90. The cable 63 connects to the inventive multiplexer 30.

Also connectable to the asynchronous input module 15 through a simple gender adapter are GENESIS gage cables available from Advanced Systems & Designs, Inc. of Troy, Mich. Either the PC 40, through its setup program, or the multiplexer 30, can perform an ID lookup of the cable. Alternatively, the part number of the cable can be entered to the setup program of the PC 40 to access the gage parameter database. Like the other embodiments of the intelligent cable, default settings are desirable. Here, default setup is to take a single reading on ready, prompt or footswitch closure. Default for the gage connector is 9600 baud, 8 data bits, no parity with 2 stop bits out, allow 1 stop bit in. In addition, other defaults for the gage connector include EIA levels with PC pinout, handshake normal. It is expected that an automatic scheme for identifying a different baud rate and DCE instead of DTE wiring will be able to adjust to a signal after four readings.

Setup can be accomplished in more than one way for the fifth and sixth embodiments. For example, setup can be accomplished serially via a passive adapter cable that connects the three-conductor jack normally used as the footswitch jack 80. The PC end of this cable would have a DB9F connector for the serial exchange during programming. The same jack is compatible with a two-wire connected switch for normal footswitch use. Alternately, setup can be accomplished when connected to the multiplexer 30 previously discussed. Setup therein includes capability of communicating to an asynchronous gage.

Two internal 16-position rotary switches of the fifth embodiment allow setups for customers not having a computer such as PC 40 or a multiplexer 30 designed according to the teachings herein. The switches typically support the selection of speed (300, 1200, 2400, 4800, 9600, 19200, 38.4 KB), prompt character, termination character, the number of terminations (e.g., 1, 2, 3, 4), whether the field is comma or space delimited (e.g., into 1, 2, 3, or 4), whether the input is streaming or not streaming, the output configuration (i.e., MIN only, MAX only or TIR on toggle type footswitch closure) and single or multiple (generally up to three) readings.

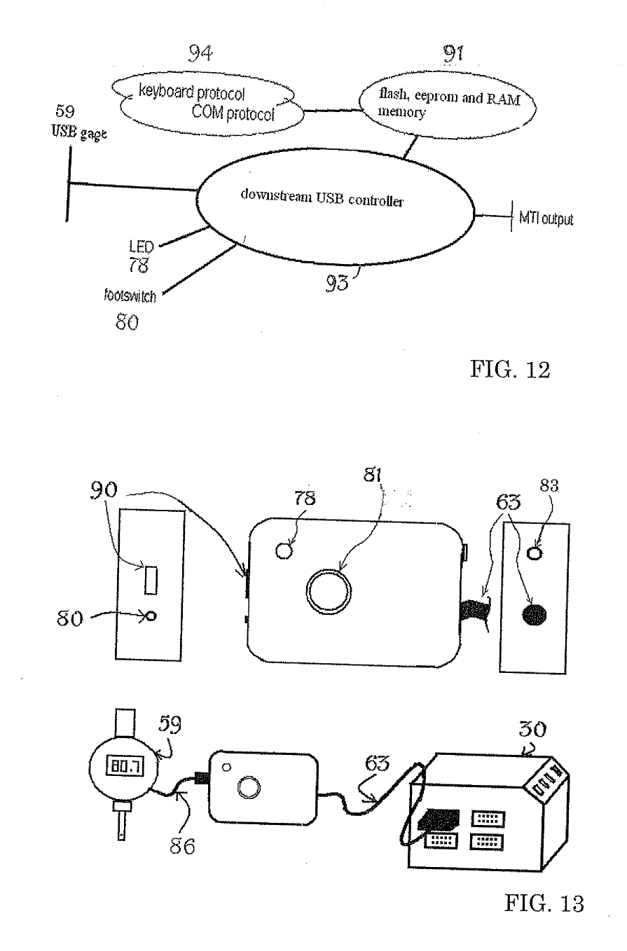

FIG. 12 is an operational diagram of an intelligent cable according to a sixth embodiment showing typical use with indicator gage with USB output 49, 84. FIG. 13 is a mechanical layout of the intelligent cable according to the sixth embodiment.

In the sixth embodiment, the input is a USB connector accepting a USB cable 86 and operating a USB host mode. The output includes an integral cable 63 with a MTI 10 pin female connector. Like the fifth embodiment, the output signal emulates an MTI signal and the synchronous bus of the multiplexer 30. Similarly, default setup is to take a single reading on ready, prompt or footswitch closure.

The USB input 86 will accept only USB signals for which the intelligent cable can act as a host controller 93. The sixth embodiment supports USB gages that emulate keyboards compatible with the standard Windows keyboard driver or supports the two most predominate USB-COM standards. For the host mode, a public keyboard protocol is reverse engineered and emulated to receive keystrokes, particularly numbers. Alternatively, one of at least two virtual COM protocols are supported. For each, a public logical COM protocol is reverse engineered and emulated to receive and transmit ASCII characters.

Internally the protocols are accomplished by use of an microcontroller designed to be a USB downstream controller 93 working with the firmware stored in FLASH memory and setup information stored in EEPROM memory (collectively, memory 91). The microcontroller's firmware has methods to emulate preferably both the Windows keyboard driver and common virtual COM drivers (collectively, protocols 94).

The USB port is not intended to work with other USB devices, but the connected gage can get power harmlessly from the USB connector 86. The controller also preferably supports a pushbutton switch and a footswitch jack and LED operation as previously described.

Setup can be accomplished as described with reference to the fifth embodiment, and two internal 16-position rotary switches allow setups as also described with reference to the fifth embodiment. If a keyboard device is detected then that will be the input protocol default.

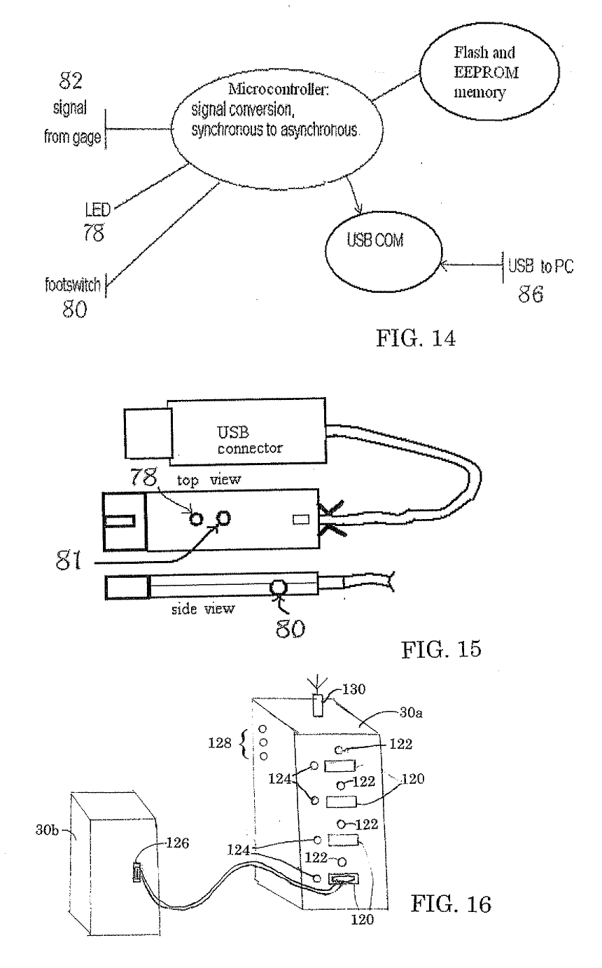

FIG. 14 is an operational diagram of an intelligent cable according to a seventh embodiment. FIG. 15 is a mechanical layout of the intelligent cable according to the seventh embodiment. In the seventh embodiment the function is similar to the second embodiment except that no rotary switches are installed, the USB keyboard emulation is not supported, and a physically smaller case is used. Footswitch jack 80 and a pushbutton switch 81 invoke gage readings. Status is displayed by LED 78.

Next described are certain considerations relevant only to the USB-connected embodiments. With respect to upstream USB considerations, the USB communication to the host, such as PC 40, is governed by three main protocols using a logical COM port through which all setup and flash updates to the intelligent cable are ported. Also, this COM protocol 94 may be used to output gage readings and to optionally receive prompt commands for gage readings. In addition, the USB keyboard protocol 94, if setup to be active, will output readings directly to an application in the same way a keyboard entry would. This is accomplished in the same way as described for the USB output of the multiplexer 30 with respect to FIG. 3 above.

Windows includes a driver for the keyboard and one type of virtual USB COM port.

Although USB keyboard emulation is generally considered an output only as described herein, the second and fourth embodiments preferably have a connection from the keyboard scroll connection to the on-board microcontroller, allowing signaling from the host to the intelligent cable when in keyboard mode.

With respect to downstream USB considerations, the sixth embodiment has a downstream USB port where the intelligent cable emulates a computer USB controller operating with a suitable driver. The necessary strings/commands depend in part on the specific driver protocol, which is different with each chip set in the connected gage.

As mentioned previously, all of the intelligent cables have a power connector except USB output types of the second, fourth and seventh embodiments. More specifically, power from a USB port on intelligent cables of the second, fourth and seventh embodiments should be adequate. However, the RS232 and MTI output versions do not have sufficient power under certain circumstances, and these require an external power supply. If these versions are used with the inventive multiplexer 30 herein described, the multiplexer 30 generally provides sufficient power. However, the intelligent cables can be connected to other types of equipment that may not provide adequate current. The power supply can be any standard off the shelf supply with an 8 to 10 volt rating. The first through fourth embodiments do not need more than 75 ma for proper operation. The fifth embodiment may require additional current when the RS232 interface of the gage derives its power from the RS232 signal; 100 ma should be sufficient. Finally, the supply for the sixth embodiment is different from the others due to the USBD 200 ma/500 ma requirements.

Embodiments of the intelligent cables, using their respective hardware and firmware, can be set up and operated by the setup program 42 and user application 44 of the PC 40. More specifically, the first through fourth and seventh embodiments can connect to PC 40 using the COM port (either conventional or via a USB COM driver) and run the setup application 42. The fifth and sixth embodiments can connect to the PC 40 through the inventive multiplexer 30. The fifth and sixth embodiments can also connect to a conventional COM port via a passive cable connecting to the three-conductor jack 80 normally used for a footswitch connection, unlike the first through fourth embodiments. The passive cable is used for setup only.

Accordingly, the software requirements of the PC 40 are applicable to the operation and setup of these intelligent cables with respect to footswitch control, triggering events for readings, setup of asynchronous gages (baud, parity, framing data), recognition of gage type, etc. Therefore, the software is not described again. With respect to the intelligent cables versus the multiplexer 30, however, there are differences in the software. When an intelligent cable is used, there is no setup ability for gage port interdependency. Multiple connected intelligent cables should be shown as separate entities to be set up individually. Further, display of screens can be limited to those that are applicable to the particular intelligent cable. For example, an asynchronous framing screen can be closed when setting up a synchronous input intelligent cable.

The intelligent cables are also compatible with other end-user software. For example, the first and third embodiments can communicate through a PC conventional COM port in the normal fashion. In order to obtain a reading, the end-user application can send a prompt message or listen only directly or through a wedge program 45. The intelligent cable according to the second and fourth embodiments can communicate via USB to operate in a like manner through the logical USB COM driver. An end-user application can listen only via the USB keyboard function and accept values via virtual keyboard entry with the exception of monitoring the SCROLL function. Since either of these embodiments is a separate USB device, a separate application running under Windows can route an event trigger (process event or detected signal) to cause a prompt to be sent via the USB COM port. The measurement value from the intelligent cable is through the USB keyboard to the SPC application.

Finally, the fifth and sixth embodiments 15, 16 can be connected to any MTI input device, such as conventional multiplexers, through a MTI/DGI adapter to the DGI multiplexer of older design manufactured by Advanced Systems and Designs, Mitutoyo printers, etc. In these cases, however, the fifth and sixth embodiments 15, 16 would not be programmable through the Mitutoyo connector 90 (unlike the comparable situation where they are connectable to embodiments of the multiplexer 30).

FIG. 16 shows a first multiplexer 30a according to the teachings herein connected to another multiplexer 30b. The first multiplexer 30a includes, by example four channels. Each channel comprises a respective input connector 120, a footswitch jack 122 and a light emitting diode 124. Each input connector 120 uses on the connector-types previously described with respect to the cables. Each footswitch jack 122 is connectible to a respective footswitch for triggering reading of data from the device connected to the input connector 120. The light emitting diodes 124 indicates a status of each of the channels in a like manner as that described with respect to the light emitting diodes of the cables.

The second multiplexer 30b is illustrated in a simplified manner as it is duplicative of the first multiplexer 30b. The output connector 126 of the multiplexer 30b is connected the multiplexer 30a through one of its input connectors 120. The multiplexers 30a, 30b then communicate through the USB interface bus 19 of the multiplexer 30b through its output connector 126. A light emitting diode display 128 indicates, for example, the operating mode of the multiplexer 30a. The multiplexer 30 can include an optional wireless base station 130 as shown in the multiplexer 30a. The wireless signal receiver base station 130 is configured to receive signals from third party gages with wireless capability, and input data from a wireless transmitter of a gage device equipped with such a transmitter.

The above-described embodiments have been described in order to allow easy understanding of the invention and do not limit the invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A cable for connecting a gage device to a processing unit, the cable comprising:
a housing;
an input connector mounted in a surface of the housing;
means for coupling the input connector to a gage output;
an output connector mounted in the surface of the housing;
means for coupling the output connector to a processing unit; and
a microprocessor arranged inside the housing and configured to receive input from the input connector and to provide output to the processing unit; and operational settings and firmware of the cable configurable using software running on the processing unit.

2. The cable according to claim 1 wherein the cable further comprises at least one of:
a pushbutton switch mounted in the surface of the housing wherein the microprocessor is configured to read data from the gage device responsive to triggering of the pushbutton switch;
a footswitch jack mounted in the surface of the housing wherein the microprocessor is configured to read data from the gage device responsive to a triggering signal received by the footswitch jack; and
at least one light emitting diode visible through the surface of the housing wherein the microprocessor is configured to control the at least one light emitting diode to indicate a status of the microcontroller.

3. The cable according to claim 1, further comprising:
a RS232 buffer coupled to the output connector; wherein the input connector is configured to receive input from a synchronous gage device and the microprocessor is configured to convert signals from the synchronous gage device to RS232-compatible asynchronous data for transmission through the RS232 buffer.

4. The cable according to claim 1, further comprising:
an internal bi-directional USB-COM port coupled to the output connector; wherein the input connector is configured to receive input from a synchronous gage device and the microprocessor is configured to convert signals from the synchronous gage device to USB-compatible data for transmission through the USB-COM port.

5. The cable according to claim 4, further comprising:
a light emitting diode display visible through the surface of the housing; wherein the microprocessor is configured to provide a first lighting pattern using the light emitting diode display to indicate communication using the USB-COM port to the processing unit and to provide a second lighting pattern using the light emitting diode display to indicate communication to the processing unit to the USB-Keyboard connection.

6. The cable according to claim 1, further comprising:
a USB keyboard output chip coupled to the output connector; wherein the input connector is configured to receive input from a synchronous gage device and the microprocessor is configured to convert signals from the synchronous gage device to USB-compatible data for transmission through the USB keyboard output chip.

7. The cable according to claim 1, further comprising:
a RS232 buffer connected to the input connector; wherein the RS232 buffer is configured to receive input from an asynchronous gage device through the input connector and the microprocessor is configured to convert signals from the RS232 buffer to synchronous data for transmission through the output connector.

8. The cable according to claim 1 wherein the microprocessor is configured to operate in USB host mode and to convert signals from a USB gage device to a synchronous data protocol for transmission through the output connector.

9. The cable according to claim 1 wherein the processing unit comprises one of a multiplexer and a personal computer in separate enclosures.

10. A multiplexer for monitoring a plurality of gage devices, at least one of the gage devices coupled to the multiplexer using a respective cable according to claim 1, the multiplexer comprising:
a housing;
a plurality of input connectors mounted in a surface of the housing;
an output connector mounted in the surface of the housing and connectible to a processing unit;
a RS232 buffer coupled to the output connector;
a bidirectional USB-COM port coupled to the output connector; and
a microprocessor arranged inside the housing and configured to:
receive input data from one of the plurality of input connectors coupled to a gage device, the input data transmitted according to one of a synchronous protocol and an asynchronous protocol; and
selectively convert the input data to one of RS232-compatible asynchronous data for transmission through the RS232 buffer to the output connector and USB-compatible data for transmission through the USB-COM port to the output connector.

11. A multiplexer for monitoring a plurality of gage devices coupled to the multiplexer, the multiplexer comprising:
a housing;
a plurality of input connectors mounted in a surface of the housing, at least one of the plurality of input connectors coupled to a gage device;
an output connector mounted in the surface of the housing and connectible to a processing unit;
a RS232 buffer coupled to the output connector;
a bi-directional USB-COM port coupled to the output connector; and
a microprocessor arranged inside the housing and configured to:
receive input data from one of the plurality of input connectors coupled to a gage device, the input data transmitted according to a synchronous protocol; and
selectively convert the input data to one of RS232-compatible asynchronous data for transmission through the RS232 buffer to the output connector and USB-compatible data for transmission through the USB-COM port to the output connector.

12. The multiplexer according to claim 11, further comprising:
a wireless base station configured to receive input data from a gage device incorporating a wireless transmitter.

13. The multiplexer according to claim 11, further comprising at least one of:
a plurality of pushbutton switches mounted in the surface of the housing and associated with respective ones of the plurality of input connectors wherein the microprocessor is configured to read data from a connected gage device responsive to triggering of a pushbutton switch;
a plurality of footswitch jacks mounted in the surface of the housing and associated with respective ones of the plurality of input connectors wherein the microprocessor is configured to read data from a connected gage device responsive to a triggering signal received by a footswitch jack; and
a plurality of light emitting diodes visible through the surface of the housing and associated with respective ones of the plurality of input connectors wherein the microprocessor is configured to control the plurality of light emitting diodes to indicate status of each of the plurality of input connectors.

14. The multiplexer according to claim 11 wherein the microprocessor is configured to trigger reading of input data from one or more of the plurality of input connectors, a software-commanded configuration of the process initiated by a push button switch or a footswitch jack.

15. The multiplexer according to claim 11 wherein the microprocessor is configured to convert a synchronous input from an individual input of the plurality of input connectors to one of RS232-compatible asynchronous data for transmission through the RS232 buffer to the output connector and USB-compatible data for transmission through the USB-COM port or USB-keyboard to the output connector, the multiplexer further comprising a cable including:
a cable housing;
a cable input connector mounted in a surface of the cable housing;
means for coupling the cable input connector to a gage output;
a cable output connector mounted in the surface of the cable housing;
means for coupling the cable output connector to another individual input of the plurality of input connectors of the multiplexer; and
a cable microprocessor arranged inside the cable housing and configured to receive input from the cable input connector and to provide output to the multiplexer; and operational settings and firmware of the cable configurable using software running on the processing unit; and wherein the microprocessor is configured to convert an asynchronous input from the cable to one of RS232-compatible asynchronous data for transmission through the RS232 buffer to the output connector and USB-compatible data for transmission through the USB-COM port to the output connector.

16. The multiplexer according to claim 11, further comprising:
a light emitting diode display visible through the surface of the housing; wherein the microprocessor is configured to provide a first lighting pattern using the light emitting diode display to indicate communication using the USB-COM port to the processing unit and to provide a second lighting pattern using the light emitting diode display to indicate communication to the processing unit using the USB-Keyboard connection.

17. The multiplexer according to claim 11, further comprising:
a USB keyboard output chip coupled to the output connector; wherein the input connector is configured to receive input from a synchronous gage device and the microprocessor is configured to convert signals from the synchronous gage device to USB-compatible data for transmission through the USB keyboard output chip.

18. The multiplexer according to claim 11 wherein the multiplexer is a first multiplexer of a plurality of multiplexers connected to each other, and wherein only the first multiplexer is connected to a personal computer for communication therewith, each of the plurality of multiplexers comprising:
a respective housing;
a respective plurality of input connectors mounted in a surface of the respective housing, at least one of the respective plurality of input connectors coupled to a respective gage device;
a respective output connector mounted in the surface of the respective housing;
a respective RS232 buffer coupled to the respective output connector;
a respective bi-directional USB-COM port coupled to the respective output connector; and
a respective microprocessor arranged inside the respective housing and configured to:
receive input data from one of the respective plurality of input connectors, the input data transmitted according to a synchronous protocol; and
selectively convert the input data to one of RS232-compatible asynchronous data for transmission through the RS232 buffer to the respective output connector and USB-compatible data for transmission through the respective USB-COM port to the respective output connector.

19. The multiplexer according to claim 18 wherein the plurality of multiplexers are configured to communicate with each other to provide a triggered process to commence on each of the plurality of multiplexers from a single footswitch jack located on any one of the plurality of multiplexers according to a setup configuration.
